(19) United States
(12) Patent Application Publication
(10) Pub. No.: US 2015/0269778 A1
(43) Pub. Date: Sep. 24, 2015

(54) IDENTIFICATION DEVICE, IDENTIFICATION METHOD, AND COMPUTER PROGRAM PRODUCT

(71) Applicant: KABUSHIKI KAISHA TOSHIBA, Tokyo (JP)

(72) Inventors: Hideaki Uchiyama, Kawasaki (JP); Akihito Seki, Yokohama (JP); Masaki Yamazaki, Tokyo (JP)

(21) Appl. No.: 14/656,845

(22) Filed: Mar. 13, 2015

(30) Foreign Application Priority Data
Mar. 20, 2014 (JP) 2014-058643

(51) Int. Cl. G06T 19/00; G06T 7/00; G06K 9/62; H04N 13/00; H04N 5/265

(52) U.S. Cl. CPC G06T 19/006; H04N 13/00; H04N 5/265; G06K 9/6267; G06K 9/6215; G06T 7/0042

(57) ABSTRACT

According to an embodiment, an identification device includes a feature calculator, an obtaining unit, and an identifying unit. The feature calculator is configured to calculate one or more captured-image features from a captured image. The obtaining unit is configured to, for each predetermined virtual image in map data, obtain identification information in which one or more virtual-image features of the each predetermined virtual image, virtual three-dimensional positions estimated to be image capturing positions of the virtual-image features, and degrees of suitability of the virtual-image features are associated with each other. The identifying unit is configured to collate the virtual-image features with the captured-image features in descending order of the degrees of suitability, and identify a three-dimensional position and an orientation of the identification device by referring to virtual three-dimensional positions associated with the virtual-image features having a highest degree of collation and by referring to the captured-image features.

### CROSS-REFERENCE TO RELATED APPLICATION

This application is based upon and claims the benefit of priority from Japanese Patent Application No. 2014-058643 filed on Mar. 20, 2014; the entire contents of which are incorporated herein by reference.

### FIELD

Embodiments described herein relate generally to an identification device, an identification method, and a computer program product.

### BACKGROUND

A technology is known in which map data made up of image features is collated with image features of images captured at target three-dimensional positions and orientations for identification, and such positions in the map data are identified which correspond to the target three-dimensional positions and orientations for identification.

However, in the conventional technologies, since the collation between the image features of the map data and the image features of images is performed by rotation, it requires time to perform identification.

### BRIEF DESCRIPTION OF THE DRAWINGS

FIG. 1 is a configuration diagram illustrating an exemplary identification device according to a first embodiment;

FIG. 2 is an explanatory diagram illustrating an exemplary method of setting virtual three-dimensional positions and orientations according to the first embodiment;

FIG. 3 is a diagram illustrating an exemplary method of generating a plurality of virtual images according to the first embodiment;

FIGS. 4 to 8 are diagrams illustrating examples of a plurality of virtual images according to the embodiment;

FIGS. 9 and 10 are explanatory diagrams illustrating exemplary collating sequences according to the first embodiment;

FIG. 11 is a flowchart for explaining an example of an identification information generation operation performed according to the first embodiment;

FIG. 12 is a flowchart for explaining an example of an identification operation performed according to the first embodiment;

FIG. 13 is a block diagram illustrating an exemplary configuration of an identification device according to a second embodiment;

FIG. 14 is an explanatory diagram illustrating an exemplary method of setting virtual three-dimensional positions and orientations according to the second embodiment; and

FIG. 15 is a flowchart for explaining exemplary operations performed according to the second embodiment.

FIG. 16 is a block diagram illustrating an exemplary hardware configuration of the identification device according to each embodiment.

### DETAILED DESCRIPTION

According to an embodiment, an identification device includes an image capturing unit, a feature calculator, a first obtaining unit, and an identifying unit. The image capturing unit is configured to capture an image. The feature calculator is configured to calculate one or more captured-image features from the captured image. The first obtaining unit is configured to, for each predetermined virtual image corresponding to positions in map data, obtain identification information in which one or more virtual-image features of the each predetermined virtual image, virtual three-dimensional positions estimated to be image capturing positions of the one or more virtual-image features, and degrees of suitability of the one or more virtual-image features are associated with each other. The identifying unit is configured to collate the one or more virtual-image features with the one or more captured-image features in descending order of the degrees of suitability, and identify a three-dimensional position and an orientation of the identification device by referring to virtual three-dimensional positions associated with the one or more virtual-image features having a highest degree of collation and by referring to the one or more captured-image features.

Exemplary embodiments of the invention are described below in detail with reference to the accompanying drawings.

### First Embodiment

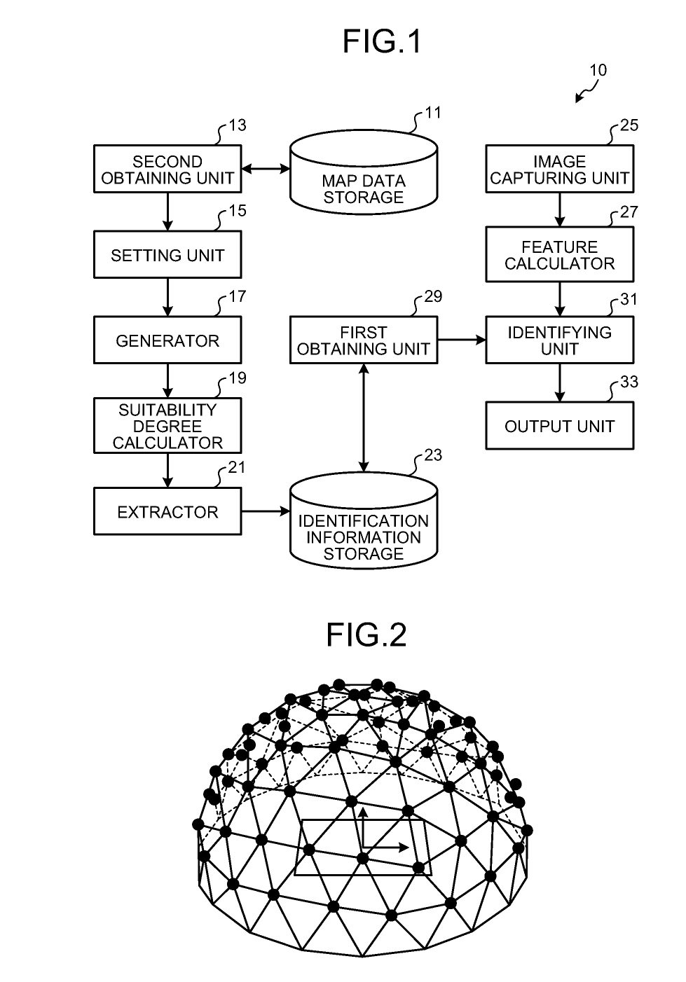

FIG. 1 is a configuration diagram illustrating an example of an identification device 10 according to a first embodiment. As illustrated in FIG. 1, the identification device 10 includes a map data memory unit 11, a second obtaining unit 13, a setting unit 15, a generator 17, a suitability degree calculator 19, an extractor 21, an identification information memory unit 23, an image capturing unit 25, a feature calculator 27, a first obtaining unit 29, an identifying unit 31, and an output unit 33. Meanwhile, the identification device 10 can be a moving object such as a robot capable of self-contained locomotion, or can be a device that is held by a user while moving around.

The map data memory unit 11 and the identification information memory unit 23 can be implemented using a storage device such as a hard disk drive (HDD), a solid state drive (SSD), a memory card, an optical disk, a read only memory (ROM), or a random access memory (RAM) in which information can be stored in a magnetic, optical, or electrical manner. The second obtaining unit 13, the setting unit 15, the generator 17, the suitability degree calculator 19, the extractor 21, the feature calculator 27, the first obtaining unit 29, the identifying unit 31, and the output unit 33 can be implemented by executing computer programs in a processor such as a central processing unit (CPU), that is, can be implemented using software; or can be implemented using hardware such as an integrated circuit (IC); or can be implemented using a combination of software and hardware. The image capturing unit 25 can be implemented using an imaging device in the form of a two-dimensional camera such as a CMOS camera (CMOS stands for Complementary Metal-Oxide Semiconductor) or a CCD camera (CCD stands for Charge Coupled Device) that captures two-dimensional images; or in the form of a three-dimensional camera, such as a TOF camera (TOF stands for Time Of Flight) or a structured light camera, that captures two-dimensional images as well as capture three-dimensional images each configured with a three-dimensional point group including the distance to the imaging target.

The map data memory unit 11 is used to store map data. Herein, map data is made up of image features of the images used in creating the map data. The image features include the feature quantity, the intensity, and the three-dimensional coordinates.

If the image feature represents a point; then the intensity can be, for example, an evaluation value indicating the degree of corners as disclosed in C. Harris and M. Stephens, “A combined corner and edge detector,” Proceedings of the 4th Alvey Vision Conference, pp. 147-151, 1988. Moreover, the three-dimensional coordinates can be, for example, the three-dimensional coordinates of the point.

If the image feature represents a line; then the intensity can be, for example, an evaluation value for calculating the degree of edges from the gradient size as disclosed in J. Canny, “A Computational Approach To Edge Detection,” IEEE Transactions on Pattern Analysis and Machine Intelligence, 8(6): 679-698, 1986. Moreover, the three-dimensional coordinates can be, for example, the three-dimensional coordinates of the gravity point of the line.

If the image feature represents an area; then the intensity can be, for example, the size of the area. Moreover, the three-dimensional coordinates can be, for example, the three-dimensional coordinates of the gravity point of the area.

The second obtaining unit 13 obtains map data. More particularly, the second obtaining unit 13 obtains map data from the map data memory unit 11.

The setting unit 15 sets a plurality of virtual three-dimensional positions on the map data obtained by the second obtaining unit 13; and sets the orientation of each virtual three-dimensional position. More particularly, the setting unit 15 sets a plurality of pairs of virtual three-dimensional positions and orientations in a circumferential manner on the map data obtained by the second obtaining unit 13.

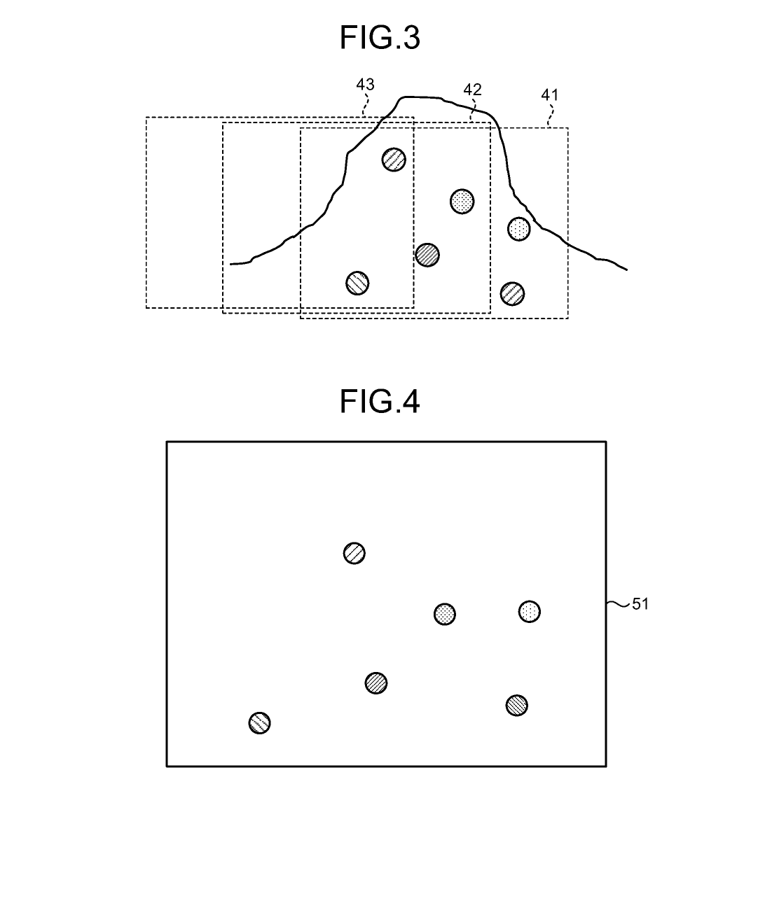

For example, as disclosed in D. Kurz, T. Olszamowski and S. Benhimane, “Representative Feature Descriptor Sets for Robust Handheld Camera Localization,” Proceedings of the International Symposium on Mixed and Augmented Reality, pp. 65-70, 2012; the setting unit 15 approximates the surface of a sphere covering a map-data-based map as a set of triangular meshes, and sets the positions and the orientations from the apices of the triangles toward the center of the sphere as virtual three-dimensional positions and orientations (see FIG. 2). Meanwhile, the setting unit 15 can arrange a plurality of spheres having different radii as the spheres covering the map-data-based map, and can set each apex in each sphere so as to set a plurality of pairs of virtual three-dimensional positions and orientations.

The generator 17 refers to a plurality of pairs of virtual three-dimensional positions and orientations set by the setting unit 15, and generates a plurality of virtual images. More particularly, for each pair of a virtual three-dimensional position and an orientation, the generator 17 generates a virtual image that is estimated to have been captured at the concerned virtual three-dimension position and the concerned orientation.

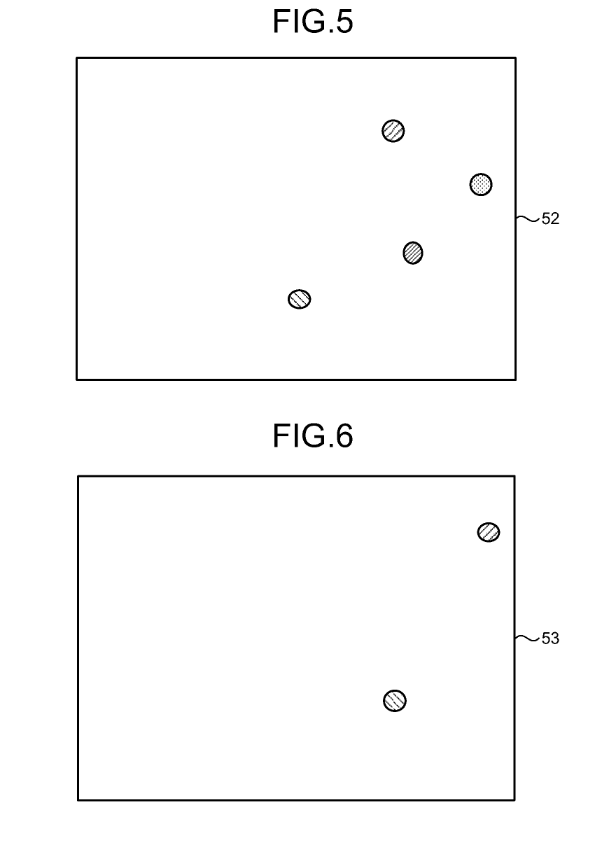

FIG. 3 is a diagram illustrating an exemplary method of generating a plurality of virtual images according to the first embodiment. In the example illustrated in FIG. 3, the space over a map-data-based map is virtually captured in imaging ranges 41 to 43, each of which corresponds to a pair of a virtual three-dimensional position and an orientation.

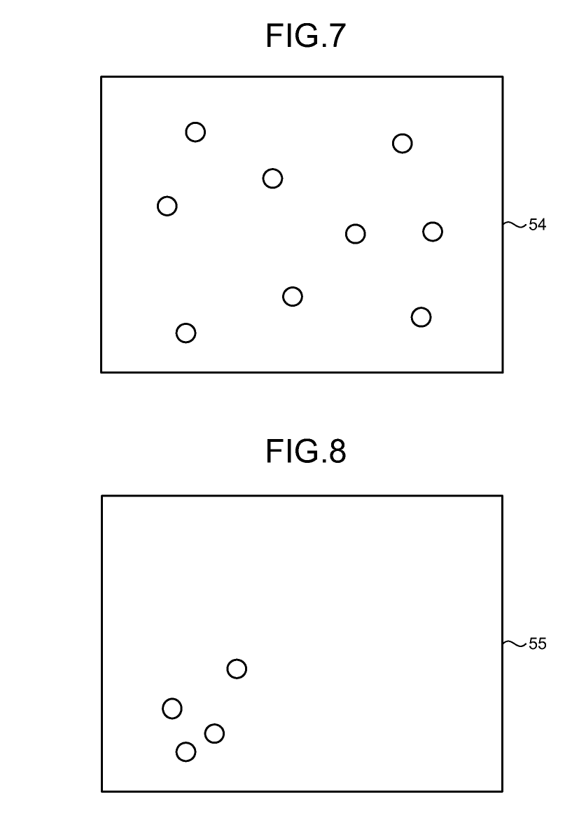

FIGS. 4 to 6 are diagrams illustrating examples of a plurality of virtual images according to the embodiment. In the example illustrated in FIG. 4, a virtual image 51 is virtually captured at the imaging range 41 illustrated in FIG. 3, and includes six image features positioned in the space over the map-data-based map. In the example illustrated in FIG. 5, a virtual image 52 is virtually captured at the imaging range 42 illustrated in FIG. 3, and includes four image features positioned in the space over the map-data-based map. In the example illustrated in FIG. 6, a virtual image 53 is virtually captured at the imaging range 43 illustrated in FIG. 3, and includes two image features positioned in the space over the map-data-based map. In the following explanation, the image features included in a virtual image are sometimes referred to as virtual-image features.

The suitability degree calculator 19 calculates, for each virtual image generated by the generator 17, one or more virtual-image features from that virtual image; and calculates degrees of suitability based on the one or more virtual-image features. More particularly, as the degree of suitability, the suitability degree calculator 19 obtains a weighted sum of following: the number of virtual-image features included in the virtual image (the number of image features positioned in the space over a map projected onto the virtual image); the sum of intensities of the virtual-image features included in the virtual image; and the distribution (variance) of the positions of the virtual feature images included in the virtual image.

Given below is the detailed explanation about the degree of suitability.

Firstly, assume that A represents the number of pairs of virtual three-dimensional positions and orientations set by the setting unit 15 where A is a natural number equal to or greater than one; tj represent virtual three-dimensional positions where j is a natural number between 1 to A; Rj represent orientations; B represents the number of image features positioned in the space over the map where B is a natural number equal to or greater than one; and Xf represents the three-dimensional coordinates of the image features where f is a natural number between 1 and B. In this case, two-dimensional coordinates xf of the image features are obtained (i.e., the three-dimensional coordinates Xf are projected onto the two-dimensional coordinates xf) using Equation (1) given below.

xf=Z[Rj|tj]Xf (1)

Herein, Z represents a matrix of internal parameters of a virtual imaging device that virtually captures virtual images. In the first embodiment, the internal parameters of the virtual imaging device are assumed to be identical to the internal parameters of the image capturing unit 25.

The suitability degree calculator 19 sets W as the width of a virtual image and sets H as the height of a virtual image, and selects the two-dimensional coordinates xf included in the concerned virtual image. With that, the virtual-image features included in that virtual image are obtained. Then, assuming that C represents the number of virtual-image features included in the virtual image, D represents the sum of intensities of the virtual-image features, and E represents the variance of the positions of the virtual-image features; degrees of suitability Sj are obtained using Equation (2) given below.

Sj=WcC+WdD+WeE (2)

Herein, We represents the number of virtual-image features; Wd represents the sum of intensities of the virtual-image features; and We represents the weight of variance of the positions of the virtual-image features.

Meanwhile, as compared to an example illustrated in FIG. 8 in which the virtual-image features are positioned close to each other in a virtual image 55, the degrees of suitability are greater in an example illustrated in FIG. 7 in which the virtual-image features are scattered in a virtual image 54.

The extractor 21 extracts, from a virtual image for which the degrees of suitability calculated by the suitability degree calculator 19 satisfy a predetermined condition, one or more virtual-image features, the virtual three-dimensional positions of the one or more virtual-image features, and the degrees of suitability; and adds the extracted information to identification information such that the one or more virtual-image features, the virtual three-dimensional positions of the one or more virtual-image features, and the degrees of suitability are associated with each other. More particularly, the extractor 21 stores, in the identification information memory unit 23, the one or more extracted virtual-image features, the virtual three-dimensional positions of the one or more virtual-image features, and the degrees of suitability in association with each other.

The identification information memory unit 23 is used to store identification information in which, for each predetermined virtual image on the map data, the following information is associated with each other: one or more virtual-image features of the predetermined virtual image; the virtual three-dimensional positions estimated to be the imaging positions of the one or more virtual-image features; and the degrees of suitability of the one or more virtual-image features. When the one or more extracted virtual-image features, the virtual three-dimensional positions of the one or more virtual-image features, and the degrees of suitability are stored in association with each other in the identification information memory unit 23 by the extractor 21; the information indicating the association of the one or more extracted virtual-image features, the virtual three-dimensional positions of the one or more virtual-image features, and the degrees of suitability gets added to the identification information.

Herein, the predetermined condition can be set to a condition of having the concerned degrees of suitability equal to or greater than a first threshold value, or a condition in which, of a plurality of degrees of suitability, the concerned degrees of suitability are within the top N number of degrees of suitability where N is a natural number equal to or greater than one.

For example, the extractor 21 sorts the degrees of suitability Sj, which are calculated by the suitability degree calculator 19, in ascending order; and either determines that the N number of degrees of suitability Sj in ascending order satisfy the predetermined condition, or compares each degree of suitability Sj, which is calculated by the suitability degree calculator 19, with the first threshold value and determines that the degrees of suitability equal to or greater than the first threshold value satisfy the predetermined condition.

Meanwhile, if any one difference of the differences between the virtual three-dimensional positions of one or more virtual-image features of a virtual image having the degrees of suitability satisfying the predetermined condition and a plurality of virtual three-dimensional positions included in the identification information is equal to or greater than a second threshold value; then the extractor 21 extracts one or more virtual-image features of the virtual image having the degrees of suitability satisfying the predetermined condition, the virtual three-dimensional positions of the one of more virtual-image features, and the degrees of suitability, and can add the extracted information in association with each other to the identification information.

Alternatively, if any one degree of similarity of the degrees of similarity between the virtual three-dimensional positions of one or more virtual-image features of a virtual image having the degrees of suitability satisfying the predetermined condition and a plurality of virtual three-dimensional positions included in the identification information is equal to or smaller than a third threshold value; then the extractor 21 extracts one or more virtual-image features of the virtual image having the degrees of suitability satisfying the predetermined condition, the virtual three-dimensional positions of the one of more virtual-image features, and the degrees of suitability, and can add the extracted information in association with each other in the identification information. Herein, the degree of similarity can be set to, for example, the number of matches of the virtual-image features.

The image capturing unit 25 captures images.

The feature calculator 27 calculates one or more captured-image features from a captured image captured by the image capturing unit 25. If the image capturing unit 25 is a two-dimensional camera, then the captured-image features include the feature quantity and the two-dimensional coordinates. If the image capturing unit 25 is a three-dimensional camera, then the captured-image features include the feature quantity and the three-dimensional coordinates. The captured-image features can be in the form of, for example, points, lines, or areas.

When the image capturing unit 25 is a two-dimensional camera, for example, the feature calculator 27 can detect a point according to the method of calculating the corner-ness as disclosed in C. Harris and M. Stephens, “A combined corner and edge detector,” Proceedings of the 4th Alvey Vision Conference, pp. 147-151, 1988.

Moreover, when the image capturing unit 25 is a two-dimensional camera, for example, the feature calculator 27 sets, as the feature quantity, a histogram as the expression of the slope distribution of pixel values of a local area around a point as disclosed in D. Lowe, “Distinctive Image Features from Scale-Invariant Keypoints,” International Journal of Computer Vision, Vol. 60, pp. 91-110, 2004.

Furthermore, when the image capturing unit 25 is a two-dimensional camera, for example, the feature calculator 27 can detect a line according to a method of calculating the slope of pixel values within a local area as disclosed in J. Canny, “A Computational Approach To Edge Detection,” IEEE Transactions on Pattern Analysis and Machine Intelligence, 8(6): 679-698, 1986.

Moreover, when the image capturing unit 25 is a two-dimensional camera, for example, the feature calculator 27 sets, as the feature quantity, a histogram as the expression of the slope distribution of pixel values of a local area around a line as disclosed in Z. Wang, F. Wu and Z. Hu, “MSLD: A robust descriptor for line matching,” Pattern Recognition, Vol. 42, pp. 941-953, 2009.

Furthermore, when the image capturing unit 25 is a two-dimensional camera, for example, the feature calculator 27 can detect an area according to a method of combining adjacent pixels having similar pixel values as disclosed in J. Matas, O. Chum, M. Urban and T. Pajdla, “Robust Wide Baseline Stereo from Maximally Stable Extremal Regions,” Proceedings of the British Machine Conference, pp. 36.1-36.10, 2002.

Moreover, when the image capturing unit 25 is a two-dimensional camera, for example, the feature calculator 27 sets, as the feature quantity, a histogram as the expression of the slop distribution of pixel values of an area that has been detected and normalized as disclosed in P. Forssen and D. Lowe, “Shape Descriptors for Maximally Stable Extremal Regions,” Proceedings of the International Conference on Computer Vision, pp. 1-8, 2007.

When the image capturing unit 25 is a three-dimensional camera, the feature calculator 27 either can convert the captured image into a distance image and detect the captured-image features of the distance image by implementing the image feature extraction method for a two-dimensional camera, or can directly make use of the three-dimensional coordinates of a point group in the captured image and detect the captured-image features.

Moreover, when the image capturing unit 25 is a three-dimensional camera, for example, the feature calculator 27 can detect a point according to a method of point detection from the local density and the adjacency relationship in a three-dimensional point group as disclosed as J. Knopp and M. Prasad and G. Willems and R. Timofte and L. Gool, “Hough Transform and 3D SURF for robust three-dimensional classification,” Proceedings of the European Conference on Computer Vision, pp. 589-602, 2010.

Furthermore, when the image capturing unit 25 is a three-dimensional camera, for example, the feature calculator 27 can detect a line according to a method of detecting a three-dimensional line by fitting a three-dimensional line model into a three-dimensional point group as disclosed in M. Kolomenkin, I. Shimshoni and A. Tal, “On edge detection on surfaces,” Proceedings of the IEEE Conference on Computer Vision and Pattern Recognition, pp. 2767-2774, 2009.

Moreover, when the image capturing unit 25 is a three-dimensional camera, for example, the feature calculator 27 can detect an area according to a method of detecting divided areas that are obtained by dividing a three-dimensional point group using the discontinuity in the adjacency relationship in the three-dimensional point group as disclosed in M. Donoser and H. Bischof, “3D Segmentation by Maximally Stable Volumes (MSVs),” Proceedings of the International Conference on Pattern Recognition, vol. 1, pp. 63-66, 2006.

When the image capturing unit 25 is a three-dimensional camera, the feature calculator 27 calculates the position of a three-dimensional point, or the position of a three-dimensional line, or the position of a three-dimensional area in a two-dimensional image; and calculates the same feature quantity as in the case of using a two-dimensional camera. That is, even when the image capturing unit 25 is a three-dimensional camera, the feature quantity can be obtained according to the same method as implemented in the case in which the image capturing unit 25 is a two-dimensional camera.

Meanwhile, the image features constituting the abovementioned map data may be created using either a two-dimensional camera or a three-dimensional camera.

The first obtaining unit 29 obtains identification information. More particularly, the first obtaining unit 29 obtains identification information from the identification information memory unit 23.

The identifying unit 31 collates one or more virtual-image features with one or more captured-image features in descending order of the degrees of suitability of the identification information, and identifies the three-dimensional position and the orientation of the identification device 10 by referring to the virtual three-dimensional positions corresponding to one or more virtual-image features having the highest degree or collation and by referring to one or more captured-image features.

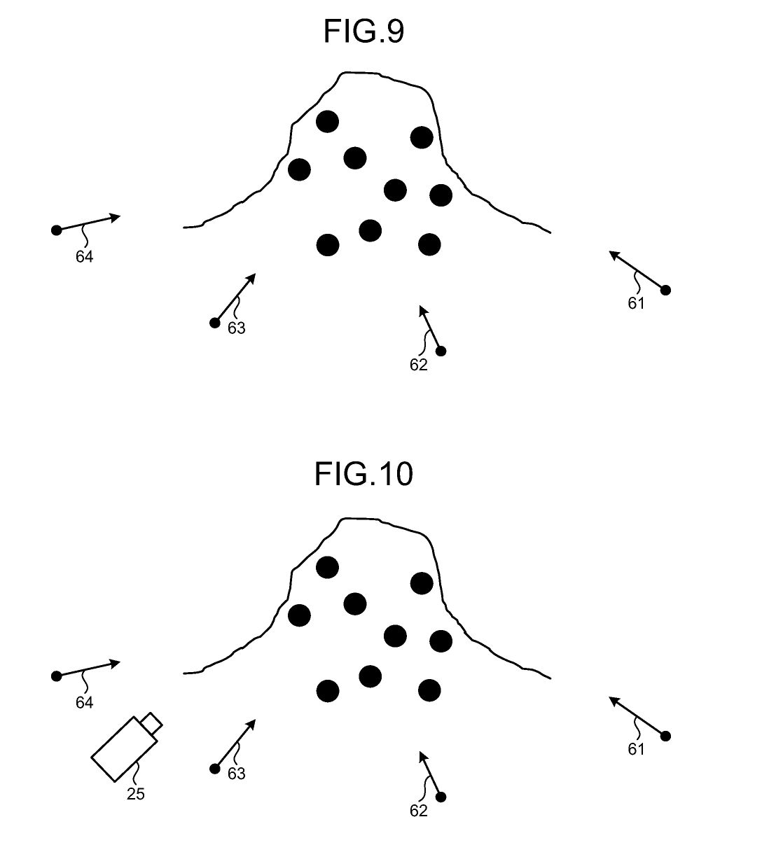

FIG. 9 is an explanatory diagram illustrating an exemplary collating sequence according to the first embodiment. In the example illustrated in FIG. 9, it is assumed that, regarding virtual three-dimensional positions 61 to 64, the degree of suitability at the virtual three-dimensional position 64 is the highest, followed by the degree of suitability at the virtual three-dimensional position 63, followed by the degree of suitability at the virtual three-dimensional position 62, and followed by the degree of suitability at the virtual three-dimensional position 61. In this case, firstly, the identifying unit 31 collates one or more virtual-image features corresponding to the virtual three-dimensional position 61 with one or more captured-image features. Then, the identifying unit 31 collates one or more virtual-image features corresponding to the virtual three-dimensional position 62 with one or more captured-image features. Moreover, the identifying unit 31 collates one or more virtual-image features corresponding to the virtual three-dimensional position 63 with one or more captured-image features. Furthermore, the identifying unit 31 collates one or more virtual-image features corresponding to the virtual three-dimensional position 64 with one or more captured-image features.

Then, if the image capturing unit 25 is a two-dimensional camera, assuming that X=(X, Y, Z) represents the virtual three-dimensional positions (three-dimensional coordinates) corresponding to one or more virtual-image features having the highest degree of collation and assuming that x=(x, y) represents the two-dimensional positions (two-dimensional coordinates) of one or more captured-image features, the identifying unit 31 obtains a rotation matrix Ra and a position vector ta that satisfy Equation (3) given below.

x=Z[Ra|ta]X (3)

Herein, the rotation matrix Ra represents the orientation of the identification device 10, and the position vector ta represents the three-dimensional position of the identification device 10. Moreover, Z represents a matrix of internal parameters of the image capturing unit 25, and can be calculated in advance using, for example, Z. Zhang, “A flexible new technique for camera calibration,” IEEE Transactions on Pattern Analysis and Machine Intelligence, Vol. 22, pp. 1330-1334, 2000.

Meanwhile, when the image capturing unit 25 is a three-dimensional camera, assuming that X=(X, Y, Z) represents the virtual three-dimensional positions (three-dimensional coordinates) corresponding to one or more virtual-image features having the highest degree of collation and assuming that X′=(X′, Y′, Z′) represents the three-dimensional positions (three-dimensional coordinates) of one or more captured-image features, the identifying unit 31 obtains the rotation matrix Ra and the position vector to that satisfy Equation (4) given below.

X′=[Rb|tb]X (4)

Meanwhile, it is also possible that the identifying unit 31 updates a plurality of degrees of suitability based on the three-dimensional position and the orientation identified on the basis of the previous captured-image features; collates one or more virtual-image features with one or more captured-image features in descending order of the updated degrees of similarity; and identifies the three-dimensional position and the orientation of the identification device 10 by referring to the virtual three-dimensional positions corresponding to one or more virtual-image features having the highest degree or collation and by referring to one or more captured-image features.

FIG. 10 is an explanatory diagram illustrating an exemplary collating sequence according to the first embodiment. In the example illustrated in FIG. 10, it is assumed that the degree of suitability at the virtual three-dimensional position 64 is the highest, followed by the degree of suitability at the virtual three-dimensional position 63, followed by the degree of suitability at the virtual three-dimensional position 62, and followed by the degree of suitability at the virtual three-dimensional position 61. However, herein, the three-dimensional position and the orientation of the image capturing unit 25 as identified based on the previous captured-image features is assumed to be as illustrated in FIG. 10. In this case, the identifying unit 31 can update the degrees of suitability by weighting the difference between the degree of suitability of the three-dimensional position and the orientation of the image capturing unit 25 as identified based on the previous captured-image features and the degree of suitability of each of the virtual three-dimensional positions 61 to 64. As a result, if the updated degree of suitability at the virtual three-dimensional position 63 happens to be the highest, followed by the updated degree of suitability at the virtual three-dimensional position 64, followed by the updated degree of suitability at the virtual three-dimensional position 61, and followed by the updated degree of suitability at the virtual three-dimensional position 62; then, firstly, the identifying unit 31 collates one or more virtual-image features corresponding to the virtual three-dimensional position 63 with one or more captured-image features. Then, the identifying unit 31 collates one or more virtual-image features corresponding to the virtual three-dimensional position 64 with one or more captured-image features. Subsequently, the identifying unit 31 collates one or more virtual-image features corresponding to the virtual three-dimensional position 61 with one or more captured-image features. Then, the identifying unit 31 collates one or more virtual-image features corresponding to the virtual three-dimensional position 62 with one or more captured-image features.

The output unit 33 outputs the identification result of the identifying unit 31. For example, the output unit 33 outputs the identification result on the screen of a display unit (not illustrated), or outputs the identification result to the map data memory unit 11, or outputs the identification result to a printing unit (not illustrated) for printing purposes.

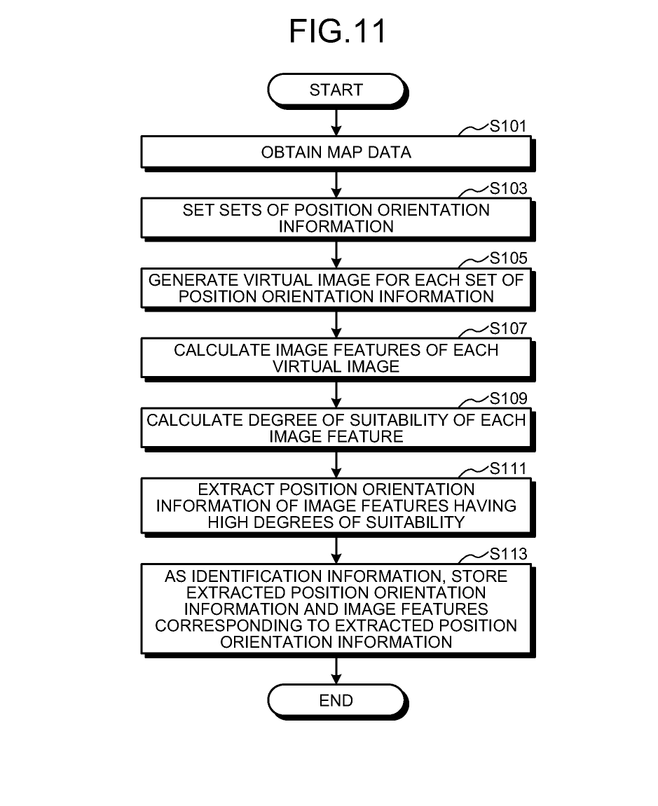

FIG. 11 is a flowchart for explaining an exemplary sequence of operations during an identification information generation operation performed in the identification device 10 according to the first embodiment.

Firstly, the second obtaining unit 13 obtains map data (Step S101).

Then, the setting unit 15 sets a plurality of pairs of virtual three-dimensional positions and orientations (a plurality of sets of position orientation information) in a circumferential manner on the map data obtained by the second obtaining unit 13 (Step S103).

Subsequently, for each pair of a virtual three-dimensional position and an orientation (for each set of position orientation information), the generator 17 generates a virtual image that is estimated to have been captured at the concerned virtual three-dimension position and the orientation (Step S105).

Then, for each virtual image generated by the generator 17, the suitability degree calculator 19 calculates one or more virtual-image features from that virtual image (Step S107); and calculates degrees of suitability based on the one or more virtual-image features (Step S109).

Subsequently, the extractor 21 extracts one or more virtual-image features in each virtual image for which the degrees of suitability calculated by the suitability degree calculator 19 satisfy a predetermined condition, extracts the virtual three-dimensional positions of the one or more virtual-image features, and extracts the degrees of suitability (Step S111); and adds the extracted information in association with each other to identification information (Step S113).

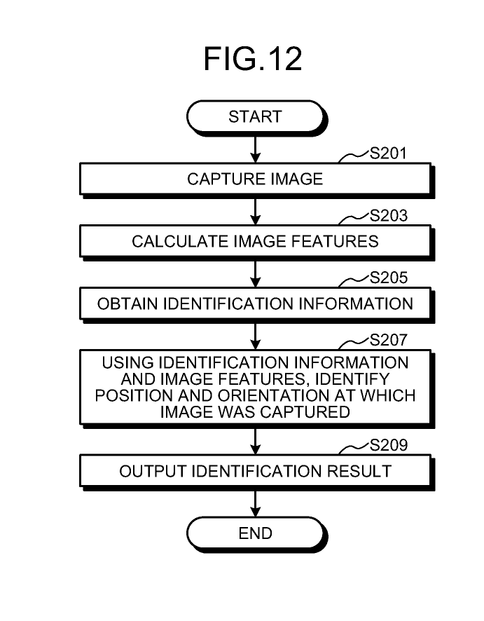

FIG. 12 is a flowchart for explaining an exemplary sequence of operations during an identification operation performed in the identification device 10 according to the first embodiment.

Firstly, the image capturing unit 25 captures an image (Step S201).

Then, the feature calculator 27 calculates one or more captured-image features from the captured image captured by the image capturing unit 25 (Step S203).

Subsequently, the first obtaining unit 29 obtains identification information from the identification information memory unit 23 (Step S205).

Then, the identifying unit 31 collates one or more virtual-image features with one or more captured-image features in descending order of the degrees of suitability of the identification information, and identifies the three-dimensional position and the orientation of the identification device 10 by referring to the virtual three-dimensional positions corresponding to one or more virtual-image features having the highest degree or collation and by referring to one or more captured-image features (Step S207).

Subsequently, the output unit 33 outputs the identification result of the identifying unit 31. For example, the output unit 33 outputs the identification result on the screen of a display unit (not illustrated), or outputs the identification result to the map data memory unit 11, or outputs the identification result to a printing unit (not illustrated) for printing purposes (Step S209).

In this way, according to the first embodiment, the virtual-image features to be used in collation during identification are extracted based on the degrees of suitability. As a result, the target virtual-image features for collation can be narrowed down in advance. That enables achieving reduction in the time required for the identification.

### Second Embodiment

In a second embodiment, the explanation is given for an example in which identification is performed while creating map data. The following explanation is given with the focus on the differences with the first embodiment. Moreover, the constituent elements having identical functions to the first embodiment are referred to by the same names and the same reference numerals, and the relevant explanation is not repeated.

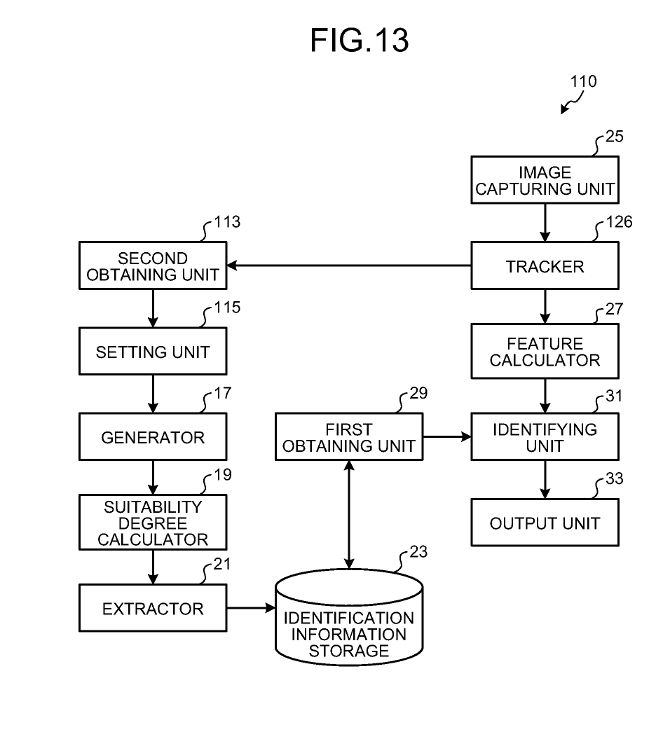

FIG. 13 is a block diagram illustrating an exemplary configuration of an identification device 110 according to the second embodiment. As illustrated in FIG. 13, in the identification device 110 according to the second embodiment, a tracker 126, a map data creator 113, and a setting unit 115 are different than the first embodiment.

The tracker 126 collates one or more captured-image features with one or more previous captured-image features. Then, if the number of captured-image features that are matching is equal to or greater than a threshold value, the tracker 126 continues with the tracking. However, if the number of captured-image features that are matching is smaller than the threshold value, then the tracker 126 ends the tracking.

When the tracker 126 continues with the tracking, the map data creator 113 creates map data by referring to the captured-image features. More particularly, the map data creator 113 adds, to map data, the captured-image features as image features constituting the map data. For example, the map data creator 113 sets the captured-image features as the image features constituting the map data according to a method disclosed in G. Klein and D. Murray, “Parallel Tracking and Mapping for Small AR Workspaces,” Proceedings of the International Symposium on Mixed and Augmented Reality, 2007.

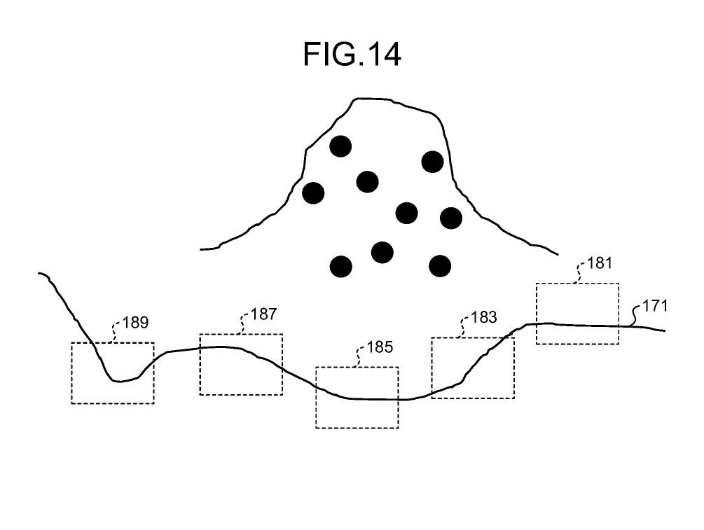

The setting unit 115 determines whether or not to set the three-dimensional positions and the orientations of the captured-image features that are treated as the image features constituting the map data. For example, as illustrated in FIG. 14, if the amount of variation among three-dimensional positions and orientations (e.g., the difference between a pair 181 of a three-dimensional position and an orientation and a pair 183 of a three-dimensional position and an orientation) is equal to or greater than a threshold value, then the setting unit 115 sets the three-dimensional positions and the orientations of the captured-image features.

If the tracker 126 fails in the tracking, then the first obtaining unit 29 obtains identification information, and the identifying unit 31 performs identification.

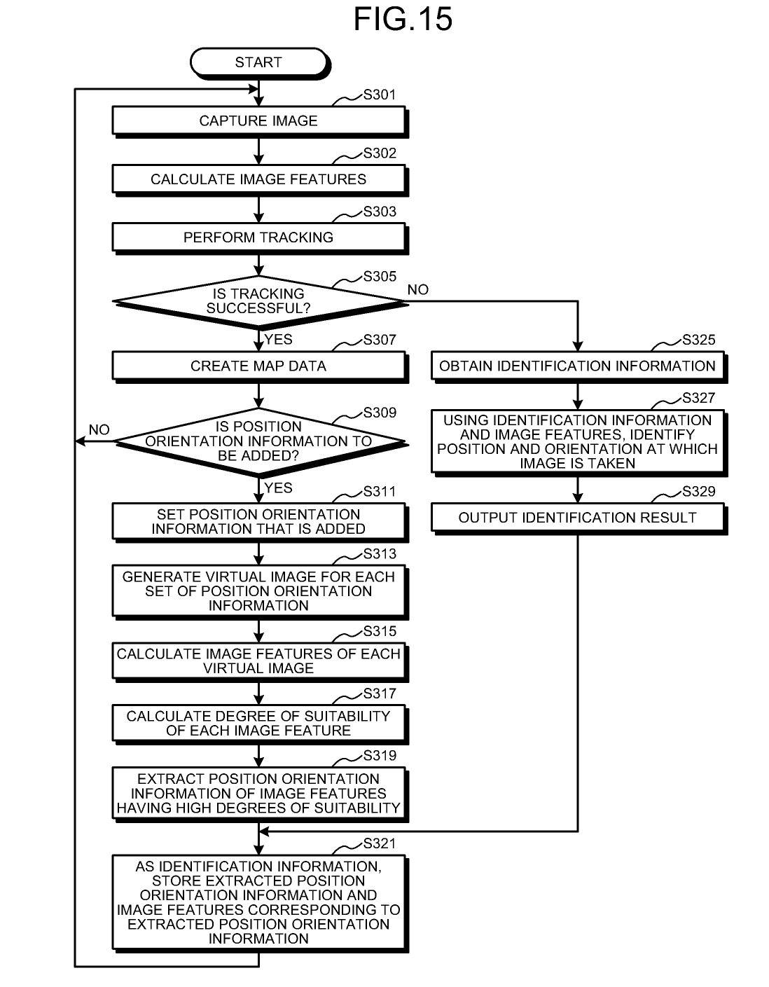

FIG. 15 is a flowchart for explaining an exemplary sequence of operations performed in the identification device 110 according to the second embodiment.

Firstly, the image capturing unit 25 captures an image (Step S301).

Then, the feature calculator 27 calculates one or more captured-image features from the captured image captured by the image capturing unit 25 (Step S302).

Subsequently, the tracker 126 collates the one of more captured-image features with one or more previous captured-image features (Step S303). If the number of captured-image features that are matching is equal to or greater than a threshold value, then the tracker 126 continues with the tracking (Yes at Step S305). However, if the number of captured-image features that are matching is smaller than the threshold value, then the tracker 126 ends the tracking (No at Step S305).

When the tracker 126 continues with the tracking (Yes at Step S305), the map data creator 113 creates map data by referring to the captured-image features (Step S307).

Then, if the three-dimensional positions and the orientations of the captured-image features, which are treated as the image features constituting the map data, are to be set (Yes at Step S309), the setting unit 15 performs that setting (Step S311).

The subsequent operations from Steps S313 to S321 are identical to the operations from Steps S105 to S113 of the flowchart illustrated in FIG. 11.

Meanwhile, when the tracker 126 ends the tracking (No at Step S305), the first obtaining unit 29 obtains identification information from the identification information memory unit 23 (Step S325).

The subsequent operations from Steps S327 and S329 are identical to the operations from Steps S207 and S209 of the flowchart illustrated in FIG. 12.

In this way, according to the second embodiment, identification can be performed while generating the map data in a dynamic manner.

Hardware Configuration

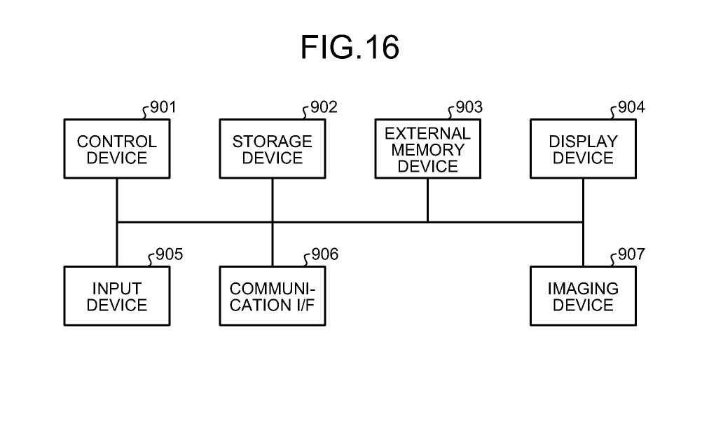

FIG. 16 is a block diagram of an exemplary hardware configuration of the identification device according to the embodiments. As illustrated in FIG. 16, the identification device according to the embodiments has the hardware configuration of a commonly-used computer that includes a control device 901 such as a central processing unit (CPU); a storage device 902 such as a read only memory (ROM) or a random access memory (RAM); an external storage device 903 such as a hard disk drive (HDD) or a solid state drive (SSD); a display device 904 such as a display; an input device 905 such as a mouse or a keyboard; a communication I/F 906; and an imaging device 907 such as a camera.

The computer programs executed in the identification device according to the embodiments are stored in advance in a ROM.

Alternatively, the computer programs executed in the identification device according to the embodiments can be recorded in the form of installable or executable files in a computer-readable recording medium such as a compact disk read only memory (CD-ROM), a compact disk readable (CD-R), a memory card, a digital versatile disk (DVD), or a flexible disk (FD), which may be provided as a computer program product.

Still alternatively, the computer programs executed in the identification device according to the embodiments can be saved as downloadable files on a computer connected to the Internet or can be made available for distribution through a network such as the Internet.

The computer programs executed in the identification device according to the embodiments contain a module for each of the abovementioned constituent elements to be implemented in a computer. As the actual hardware, for example, the control device 901 reads the computer programs from the external storage device 903 and runs them such that the computer programs are loaded in the storage device 902. As a result, the module for each of the abovementioned constituent elements is implemented in the computer.

As explained above, according to the embodiments, it becomes possible to cut down on the time required for identification.

For example, unless contrary to the nature thereof, the steps of the flowcharts according to the embodiments described above can have a different execution sequence, can be executed in plurality at the same time, or can be executed in a different sequence every time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An identification device comprising:
an image capturing unit configured to capture an image;
a feature calculator configured to calculate one or more captured-image features from the captured image;
a first obtaining unit configured to, for each predetermined virtual image corresponding to positions in map data, obtain identification information in which one or more virtual-image features of the each predetermined virtual image, virtual three-dimensional positions estimated to be image capturing positions of the one or more virtual-image features, and degrees of suitability of the one or more virtual-image features are associated with each other; and
an identifying unit configured to collate the one or more virtual-image features with the one or more captured-image features in descending order of the degrees of suitability, and identify a three-dimensional position and an orientation of the identification device by referring to virtual three-dimensional positions associated with the one or more virtual-image features having a highest degree of collation and by referring to the one or more captured-image features.

2. The device according to claim 1, wherein the identifying unit is configured to
update the degrees of suitability based on the three-dimensional position and the orientation identified on the basis of one or more previous captured-image features,
collate the one or more virtual-image features with the one or more captured-image features in descending order of the updated degrees of similarity, and
identify the three-dimensional position and the orientation of the identification device by referring to virtual three-dimensional positions associated with one or more virtual-image features having a highest degree of collation and by referring to the one or more captured-image features.

3. The device according to claim 1, further comprising:
a second obtaining unit configured to obtain the map data;
a setting unit configured to set the virtual three-dimensional positions in the map data and set orientations of the respective virtual three-dimensional positions;
a generator configured to generate the virtual images using pairs of the virtual three-dimensional positions and orientations;
a suitability degree calculator configured to calculate one or more virtual-image features from each of the virtual images and calculate the degrees of suitability based on the one or more virtual-image features; and
an extractor configured to extract one or more virtual-image features in the virtual image for which the degrees of suitability satisfy a predetermined condition, virtual three-dimensional positions of the one or more virtual-image features, and the degrees of suitability, and add the extracted one or more virtual-image features, the extracted virtual three-dimensional positions, and the extracted degrees of suitability to the identification information such that the extracted one or more virtual-image features, the extracted virtual three-dimensional positions, and the extracted degrees of suitability are associated with each other.

4. The device according to claim 3, wherein each of the degrees of suitability represents a weighted sum of the number of one or more virtual-image features, a sum of intensities of the one or more virtual-image features, and a distribution of positions of the one or more virtual feature images.

5. The device according to claim 3, wherein the predetermined condition is set to a condition that each of the degrees of suitability is equal to or greater than a first threshold value, or a condition that the degrees of suitability are within top N number of degrees of suitability where N is a natural number equal to or greater than one.

6. The device according to claim 3, wherein the extractor is configured to, when any one of differences between the virtual three-dimensional positions of the one or more virtual-image features of the virtual image having the degrees of suitability satisfying the predetermined condition and the respective virtual three-dimensional positions included in the identification information is equal to or greater than a second threshold value, extract the one or more virtual-image features of the virtual image having the degrees of suitability satisfying the predetermined condition, extract the virtual three-dimensional positions of the one of more virtual-image features, and extract the respective degrees of suitability.

7. The device according to claim 3, wherein the extractor is configured to, when any one of degrees of similarity between the one or more virtual-image features of the virtual image having the degrees of suitability satisfying the predetermined condition and the respective virtual-image features included in the identification information is equal to or smaller than a third threshold value, extract the one or more virtual-image features of the virtual image having the degrees of suitability satisfying the predetermined condition, extract the virtual three-dimensional positions of the one of more virtual-image features, and extract the respective degrees of suitability.

8. The device according to claim 3, wherein the setting unit is configured to set a plurality of pairs of the virtual three-dimensional position and the orientation in a circumferential manner on the map data.

9. The device according to claim 1, further comprising:
a tracker configured to collate the one or more captured-image features with one or more previous captured-image features and determine whether or not to end the tracking based on the number of captured-image features that matches; and
a map data creator configured to create the map data when tracking is to be ended.

10. An identification method comprising:
capturing an image;
calculating one or more captured-image features from the captured image;
obtaining, for each predetermined virtual image corresponding to positions in map data, identification information in which one or more virtual-image features of the each predetermined virtual image, virtual three-dimensional positions estimated to be image capturing positions of the one or more virtual-image features, and degrees of suitability of the one or more virtual-image features are associated with each other;
collating the one or more virtual-image features with the one or more captured-image features in descending order of the degrees of suitability; and
identifying a three-dimensional position and an orientation of the identification device by referring to virtual three-dimensional positions associated with the one or more virtual-image features having a highest degree of collation and by referring to the one or more captured-image features.

11. A computer program product comprising a computer-readable medium containing a program executed by a computer, the program causing the computer to execute:
capturing an image;
calculating one or more captured-image features from the captured image;
obtaining, for each predetermined virtual image corresponding to positions in map data, identification information in which one or more virtual-image features of the each predetermined virtual image, virtual three-dimensional positions estimated to be image capturing positions of the one or more virtual-image features, and degrees of suitability of the one or more virtual-image features are associated with each other;
collating the one or more virtual-image features with the one or more captured-image features in descending order of the degrees of suitability; and
identifying a three-dimensional position and an orientation of the identification device by referring to virtual three-dimensional positions associated with the one or more virtual-image features having a highest degree of collation and by referring to the one or more captured-image features.
